(19) United States
(12) Patent Application Publication
(10) Pub. No.: US 2012/0321150 A1
(43) Pub. Date: Dec. 20, 2012

(54) Apparatus and Method for a Virtual Keypad Using Phalanges in the Finger

(75) Inventors: Vinoth Ranganathan, Bangalore (IN); Manikandan Selvaraju, Bangalore (IN)

(73) Assignee: Nokia Corporation, Espoo (FI)

(21) Appl. No.: 13/580,968

(22) PCT Filed: Jan. 20, 2011
(86) PCT No.: PCT/IB2011/050260

§ 371 Date: Aug. 24, 2012

(30) Foreign Application Priority Data
Feb. 25, 2010 (IN) 494/CHE/2010

(51) Int. Cl. G06K 9/00

(52) U.S. Cl. 382/124

(57) ABSTRACT

An apparatus is provided that includes a fingerprint reader and a communication device, where the glove is configured to be worn on one of a finger or a thumb of a hand and where the fingerprint reader is configured to read fingerprint data from each of the fingerprints of the fingers on the hand. The apparatus may also include a processing device, wherein the processing device is configured to associate fingerprint data read from a first fingerprint with a first function. The communication device may be configured to provide for transmission of the first function. The processing device may also be configured to associate fingerprint data read from a second fingerprint with a second function. The communication device may also be configured to provide for transmission of the fingerprint data.

### TECHNICAL FIELD

Example embodiments of the present invention generally relate to communication technology, and more particularly, relate to an apparatus and method for a remote user input device using surfaces of the phalanges of the fingers as input keys.

### BACKGROUND

The modem communications era has brought about a tremendous expansion of wireline and wireless networks. Computer networks, television networks, and telephony networks are experiencing an unprecedented technological expansion fueled by consumer demands. Together with these expanding network capabilities and communication speeds, the devices that use these networks have experienced tremendous technological steps forward in capabilities, features, and user interface. Such devices may also use accessories such as a Bluetooth™ headsets or wired headsets with limited functional capabilities. Devices communicating via these networks may be used for a wide variety of purposes including, among other things, Short Messaging Services (SMS), Instant Messaging (IM) service, E-mail, voice calls, music recording/playback, video recording/playback, and internet browsing. Such capabilities have made these devices a very desirable for those wishing to stay in touch and make themselves available to others.

Hands free devices have increased in popularity through the advent of laws prohibiting hand-held mobile device usage when driving a vehicle and the desire of users to communicate without monopolizing the use of a hand. Such devices may include a wired headset that is physically connected to a mobile device or a Bluetooth™ headset that is connected to a mobile device through a wireless Personal Area Network connection. Additionally, Bluetooth™ vehicle accessories may allow a user to use a speaker and microphone within a vehicle to communicate over their mobile device. Such devices may enable the user of a mobile device to carry on a voice call through their mobile device without having to hold the device. Further, a Bluetooth™ headset or vehicle accessory may allow a user to carry on a voice call while the device remains in a purse, pocket, glove box, or other nearby location that may not be readily accessible. Such Bluetooth™ devices or headsets and vehicle accessories using other communications protocols may have limited functionality with respect to the device to which they are paired or synchronized. For example, a Bluetooth™ headset may be capable of adjusting the volume of a speaker, answering an incoming call, and ending a call.

While accessories exist that enable a user to carry on a phone call, few accessories provide more than a limited amount of functionality with respect to the device to which they are paired. As such, the need may exist for a user input device that does not require physical manipulation of a mobile device.

### BRIEF SUMMARY

In general, exemplary embodiments of the present invention provide an improved method of providing input to a user device. In particular, the method of example embodiments provides for obtaining fingerprint data regarding a surface of any one of a plurality of phalanges of one or more fingers and associating the fingerprint data with predefined fingerprint data of a respective phalange of a finger. The method may further include determining a function associated with the predefined fingerprint data, wherein different functions are associated with the predefined fingerprint data of different respective phalanges of one or more fingers and directing that the function be initiated. The method may also include providing a confirmation in response to associating the fingerprint data with predefined fingerprint data of a respective phalange of a finger. Determining the function associated with the predefined fingerprint data may include referencing a function map where the function map may be user selectable from a plurality of function maps. The function associated with the predefined fingerprint data may casue a phone call to be initiated. Directing that the function be initiated may cause a user device to perform the function associated with the predefined fingerprint data. Directing that the function be initiated may include providing for transmission of the function over a personal wireless area network.

According to another embodiment of the invention, an apparatus may be provided that includes at least one processor and at least one memory including computer program code where the at least one memory and the computer program code are configured to, with the at least one processor, cause the apparatus to obtain fingerprint data regarding a surface of any one of a plurality of phalanges of one or more fingers and associate the fingerprint data with predefined fingerprint data of a respective phalange of a finger. The apparatus may further determine a function associated with the predefined fingerprint data, wherein different functions are associated with the predefined fingerprint data of different respective phalanges of one or more fingers and direct that the function be initiated. The apparatus may further provide for a confirmation in response to associating the fingerprint data with predefined fingerprint data of a respective phalange of a finger. To determine a function associated with the predefined fingerprint data the apparatus may be caused to reference a function map and the function map may be selectable by a user from a plurality of function maps. To direct that the function be initiated the apparatus may be caused to provide for transmission of the function over a personal wireless area network. The apparatus may be configured to be worn by a user on a thumb or a finger.

According to still another embodiment of the invention, a computer program product is provided that comprises at least one computer-readable storage medium having computer-readable program instructions stored therein, the computer-readable program instructions configured to cause an apparatus to at least obtain fingerprint data regarding a surface of any one of a plurality of phalanges of one or more fingers and associate the fingerprint data with predefined fingerprint data of a respective phalange of a finger. The computer program product may further include program code instructions for determining a function associated with the predefined fingerprint data, wherein different functions are associated with the predefined fingerprint data of different respective phalanges of one or more fingers and program code instructions for directing that the function be initiated. The program code instructions for determining a function associated with the predefined fingerprint data may include program code instructions for referencing a function map. The computer program product may further include program code instructions for providing for a confirmation in response to associating the fingerprint data with predefined fingerprint data of a respective phalange of a finger.

According to yet another embodiment of the present invention, an apparatus is provided that includes a fingerprint reading device and a communication device, where the glove is configured to be worn on one of a finger or a thumb of a hand and where the fingerprint reader is configured to read fingerprint data from each of the fingerprints of the fingers on the hand. The apparatus may also include a processing device, wherein the processing device is configured to associate fingerprint data read from a first fingerprint with a first function. The communication device may be configured to provide for transmission of the first function. The processing device may also be configured to associate fingerprint data read from a second fingerprint with a second function. The communication device may also be configured to provide for transmission of the fingerprint data. The apparatus may be configured as a glove or as a band comprising a substantially circular shape, among other wearable forms.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an communication system in accordance with an example embodiment of the present invention;

FIG. 2 is a schematic block diagram of a mobile device according to an example embodiment of the present invention;

FIG. 3 is an illustration of a remote user input device according to an example embodiment of the present invention;

FIG. 4 is an illustration of the fingerprints on the back of a user's medial phalanges;

FIG. 5 is an illustration of the fingerprints on the front of a user's fingers including prescribed functions according to an example embodiment of the present invention;

FIG. 6 is an illustration of the fingerprints on the front of a user's fingers including prescribed functions according to another example embodiment of the present invention; and

FIG. 7 is flow chart of a method of user input according to an example embodiment of the present invention.

### DETAILED DESCRIPTION OF THE INVENTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

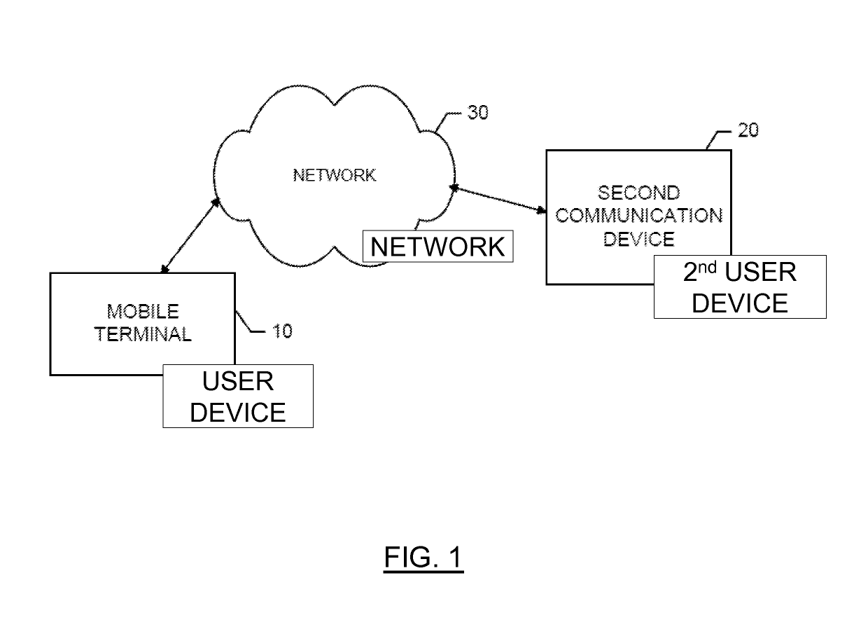

A session may be supported by a network 30 as shown in FIG. 1 that may include a collection of various different nodes, devices or functions that may be in communication with each other via corresponding wired and/or wireless interfaces. As such, FIG. 1 should be understood to be an example of a broad view of certain elements of a system that may incorporate example embodiments of the present invention and not an all inclusive or detailed view of the system or the network 30. Although not necessary, in some example embodiments, the network 30 may be capable of supporting communication in accordance with any one or more of a number of first-generation (1G), second-generation (2.G), 2.5G, third-generation (3G), 3.5G, 3.9G, fourth-generation (4G) mobile communication protocols. and/or the like.

One or more communication terminals such as the user device 10 and the second user device 20 may be in communication with each other via the network 30 and each may include an antenna or antennas for transmitting signals to and for receiving signals from a base site, which could be, for example a base station that is part of one or more cellular or mobile networks or an access point that may be coupled to a data network, such as a local area network (LAN), a metropolitan area network (MAN), and/or a wide area network (WAN), such as the Internet. In turn, other devices (e.g., personal computers, server computers or the like) may be coupled to the user device 10 and the second user device 20 via the network 30. By directly or indirectly connecting the user device 10 and the second user device 20 and other devices to the network 30, the user device 10 and the second user device 20 may be enabled to communicate with the other devices or each other, for example, according to numerous communication protocols including Hypertext Transfer Protocol (HTTP) and/or the like, to thereby carry out various communication or other functions of the user device 10 and the second user device 20, respectively.

In example embodiments, either of the user devices may be mobile or fixed communication devices. Thus, for example, the user device 10 and the second user device 20 could be, or be substituted by, any of personal computers (PCs), personal digital assistants (PDAs), wireless telephones, desktop computer, laptop computer, mobile computers, cameras, video recorders, audio/video players, positioning devices, game devices, television devices, radio devices, or various other devices or combinations thereof.

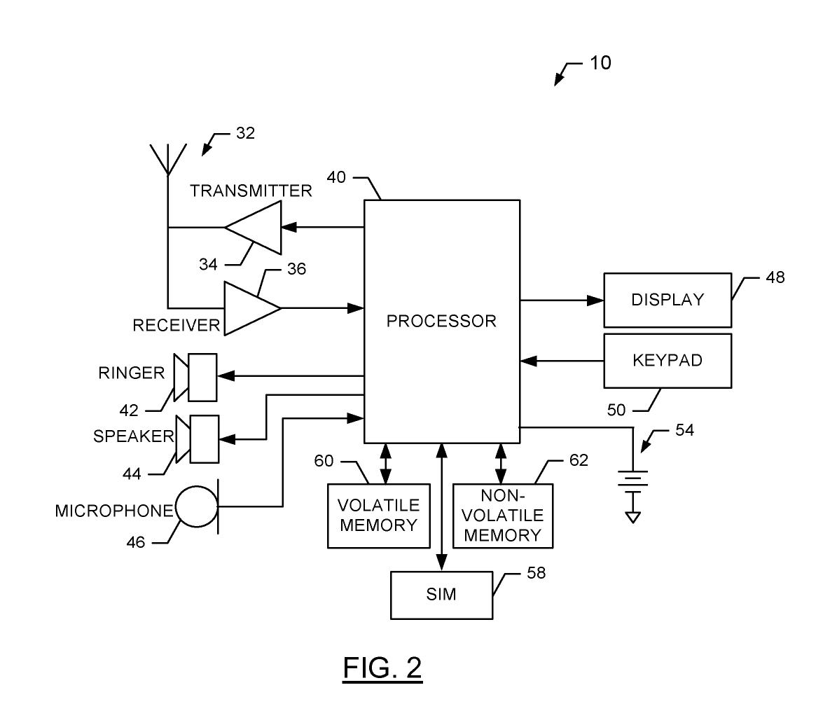

Although the user device 10 may be configured in various manners, one example of a user device that could benefit from embodiments of the invention is depicted in the block diagram of FIG. 2. While several embodiments of the user device may be illustrated and hereinafter described for purposes of example, other types of user devices, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communication devices, may employ embodiments of the present invention. As described, the user device may include various means for performing one or more functions in accordance with embodiments of the present invention, including those more particularly shown and described herein. It should be understood, however, that a user device may include alternative means for performing one or more like functions, without departing from the spirit and scope of the present invention.

The user device 10 illustrated in FIG. 2 may include an antenna 32 (or multiple antennas) in operable communication with a transmitter 34 and a receiver 36. The user device may further include an apparatus, such as a processor 40, that provides signals to and receives signals from the transmitter and receiver, respectively. The signals may include signaling information in accordance with the air interface standard of the applicable cellular system, and/or may also include data corresponding to user speech, received data and/or user generated data. In this regard, the user device may be capable of operating with one or more air interface standards, communication protocols, modulation types, and access types. By way of illustration, the user device may be capable of operating in accordance with any of a number of first, second, third and/or fourth-generation communication protocols or the like. For example, the user device may be capable of operating in accordance with second-generation (2G) wireless communication protocols IS-136, GSM and IS-95, or with third-generation (3G) wireless communication protocols, such as UMTS, CDMA2000, wideband CDMA (WCDMA) and time division-synchronous CDMA (TD-SCDMA), with 3.9G wireless communication protocols such as E-UTRAN (evolved-UMTS terrestrial radio access network), with fourth-generation (4G) wireless communication protocols or the like. The user device may further be capable of communication over wireless Personal Area Networks (WPANs) such as IEEE 802.15, Bluetooth, low power versions of Bluetooth, infrared (IrDA), ultra wideband (UWB), Wibree, Zigbee or the like.

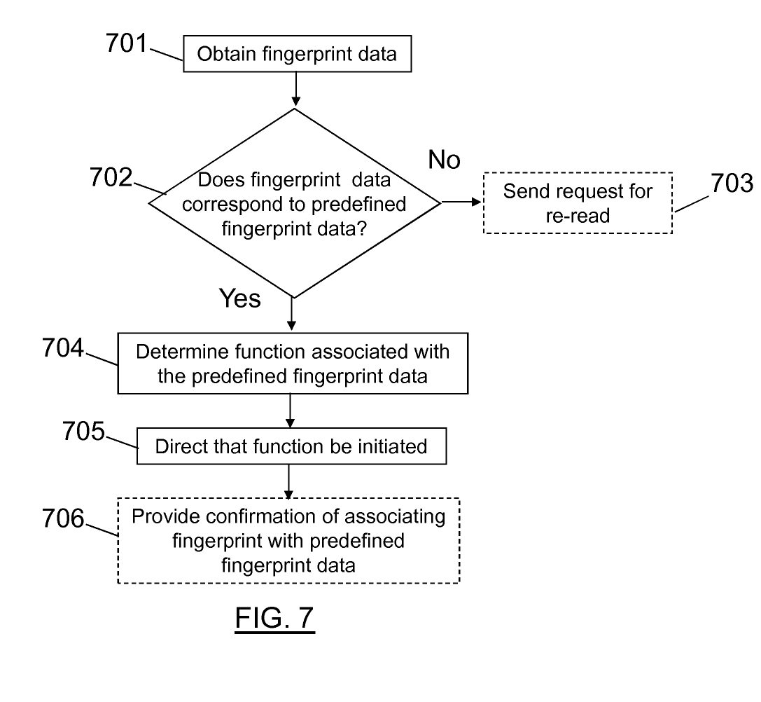

It is understood that the apparatus, such as the processor 40, may include circuitry implementing, among others, audio and logic functions of the user device 10. The processor may be embodied in a number of different ways. For example, the processor may be embodied as various processing means such as processing circuitry, a coprocessor, a controller or various other processing devices including integrated circuits such as, for example, an ASIC (application specific integrated circuit), an FPGA (field programmable gate array), a hardware accelerator, and/or the like. In an example embodiment, the processor may be configured to execute instructions stored in a memory device or otherwise accessible to the processor. As such, the processor may be configured to perform the processes, or at least portions thereof, discussed in more detail below with regard to FIG. 7. The processor may also include the functionality to convolutionally encode and interleave message and data prior to modulation and transmission. The processor may additionally include an internal voice coder, and may include an internal data modem.

The user device 10 may also comprise a user interface including an output device such as an earphone or speaker 44, a ringer 42, a microphone 46, a display 48, and a user input interface, which may be coupled to the processor 40. The user input interface, which allows the user device to receive data, may include any of a number of devices allowing the user device to receive data, such as a keypad 50, a touch display (not shown) or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the user device may include an interface device such as a joystick or other user input interface. The user device may further include a battery 54, such as a vibrating battery pack, for powering various circuits that are used to operate the user device, as well as optionally providing mechanical vibration as a detectable output.

The user device 10 may further include a user identity module (UIM) 58, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the user device may be equipped with memory. For example, the user device may include volatile memory 60, such as volatile Random Access Memory (RAM) including a cache area for the temporary storage of data. The user device may also include other non-volatile memory 62, which may be embedded and/or may be removable. The non-volatile memory may additionally or alternatively comprise an electrically erasable programmable read only memory (EEPROM), flash memory or the like. The memories may store any of a number of pieces of information, and data, used by the user device to implement the functions of the user device. For example, the memories may include an identifier, such as an international mobile equipment identification (IMEI) code, capable of uniquely identifying the user device. Furthermore, the memories may store instructions for determining cell id information. Specifically, the memories may store an application program for execution by the processor 40, which determines an identity of the current cell, e.g., cell id identity or cell id information, with which the user device is in communication.

An example embodiment of a communication network in accordance with one example embodiment is presented by FIG. 1. The flowcharts illustrating operations performed by or in relation to the network of example embodiments are presented in FIG. 7 and may be performed, for example, by the user device such as shown in FIGS. 2 and/or 3. It will be understood that each block of the flowcharts, and combinations of blocks in the flowcharts, may be implemented by various means, such as hardware, firmware, processor, circuitry and/or other device(s) associated with execution of software including one or more computer program instructions. For example, one or more of the procedures described above may be embodied by computer program instructions. In this regard, the computer program instructions which embody the procedures described above may be stored by a memory device 60, 62 of an apparatus, such as a client, employing an example embodiment of the present invention and executed by a processor 40 in the apparatus. As will be appreciated, any such computer program instructions may be loaded onto a computer or other programmable apparatus (e.g., hardware), such as depicted in FIG. 2, to produce a machine, such that the resulting computer or other programmable apparatus embody means for implementing the functions specified in the flowchart block(s). These computer program instructions may also be stored in a computer-readable memory that may direct a computer or other programmable apparatus, e.g., the overlay network host, to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions. The function of each operation of the flowcharts described herein may be performed by a processor bringing about the operation or transformation set forth in the flow chart operations.

In general, example embodiments of the present invention provide a method for entering user input into a device though an accessory device. Devices, and particularly mobile devices such as a mobile phone, may use a variety of accessories intended to improve the user interface and more seamlessly integrate the device with a user's daily activities. Such devices may include wired or wireless headsets that enable a user to engage in a voice call through their device without requiring the device to be at or near the user's ear or mouth. Such accessories include Bluetooth™ headsets that may allow a user to merely be in proximity to the device while actively carrying on a conversation via the device. Such headsets prove valuable when the user is otherwise occupied, such as when the user is driving, or performing any task that may require the use of both hands. While the wired and wireless headsets provide an improved method of conversing via a device, initiating a voice call or activating other features of a device may still require the device to be physically manipulated.

Embodiments of the present invention may allow the user of a device, such as user device 10, to interact with the user device without requiring physical manipulation of the device. The remote user input device of embodiments of the present invention may allow a user to dial a phone number from a mobile phone or interact with an application available on the user device without handling the user device itself. Such a remote user input device may be desirable when a user is driving a vehicle, jogging, or if the user is simply seeking an easier way to perform functions on a user device. Embodiments of the present invention may use the skin surfaces of phalanges in the fingers of a user as a user interface for a user device to which the remote user input device is paired or synchronized.

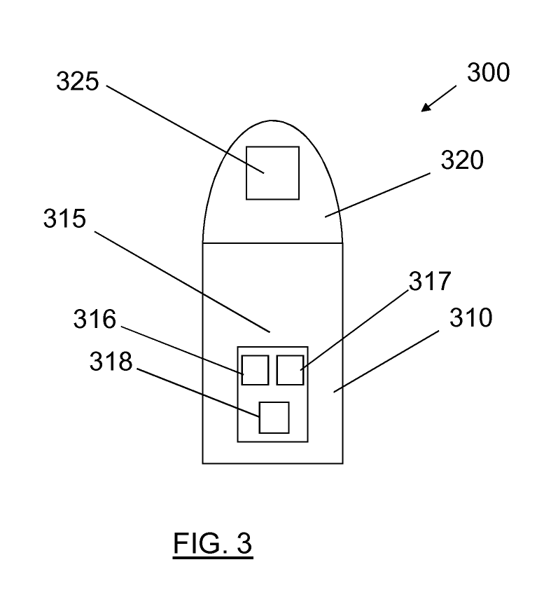

FIG. 3 illustrates a remote user input device according to an example embodiment of the present invention. The illustrated embodiment includes a glove 300 that is worn by a user, such as on the thumb. The glove may include a proximal portion 310 and a distal portion 320. The proximal portion 310 may be configured to be situated on a user's proximal phalanges of the thumb while the distal portion 320 may be configured to be situated on the distal phalanges of the user's thumb, commonly referred to as the thumb-tip.

Various embodiments of the present invention may include an apparatus 315 within or otherwise carried by the glove 300, such as at the proximal portion 310 as depicted in FIG. 3. The apparatus 315 may include a means for communication, such as a communication device 316 capable of communicating over wireless networks, such as wireless Personal Area Networks, for example Bluetooth™. The apparatus 315 may further include means for processing data such as a processor 317 or hardware with the processing capabilities necessary for implementation of embodiments of the present invention. The distal portion 320 of the glove 300 may include means for obtaining fingerprint data, such as a fingerprint reading device 325 or fingerprint reader capable of quickly obtaining fingerprint data when placed in close proximity to or in contact with a fingerprint. The “reading” or “obtaining” of a fingerprint may include scanning a fingerprint and converting the scanned image into data that may be easily communicated between a remote user input device and a user device. Thus, a read or scanned fingerprint becomes “fingerprint data” that is then used by embodiments of the invention described herein.

The remote user input device itself may be “paired” or synchronized with a device (e.g., establish a unique path of communication shared only between the remote user input device and the user device), such as a mobile device, through a wireless Personal Area Networks such as for example Bluetooth™ which would prevent the input device from interfering with other user devices and would prevent other user devices from interfering with the input of the paired user device. The “pairing” may occur at the time of manufacture if a user device is to be sold with a remote user input device according to embodiments of the present invention, or the “pairing” may be performed by a user in instances where the input device is sold separately as an accessory.

The skin surfaces of the front and back of the proximal, intermediate, and distal phalanges of each finger include unique characteristics such that each surface of each of the phalanges can be uniquely identified based on those characteristics. The fingerprint reading device 325 of embodiments of the present invention may be configured with means to detect these unique characteristics and the apparatus 315 may determine which of the surfaces of the phalanges matches the characteristics detected by the fingerprint reading device 325.

As the skin surfaces or fingerprints differ for each person and necessarily differ between fingers of an individual, remote user input devices according to example embodiments of the present invention may require a “learning” mode to learn the unique characteristics of each of the front and back surfaces of each of the phalanges of the index, middle, ring, and pinky fingers for a given user. A learning mode may require a user of the remote user input device 300 to place the fingerprint reading device 325 of the glove 300 on each surface of each phalange and identify which finger and phalange they are contacting. A learning application may be executed by a device which guides a user through the learning mode by instructing the user which finger, phalange, and surface to contact as a form of calibration. This learning mode may store fingerprint data information for a user such that when a fingerprint is obtained, the fingerprint data is compared to the fingerprint data of stored fingerprints to determine which finger and which phalange corresponds to the obtained fingerprint data. The fingerprint data information may be stored on a memory 318 within the apparatus 315 of the glove 300 of the remote user input device. This stored data becomes the predefined fingerprint data. The fingerprint data may also be stored in the user device that is “paired” with the remote user input device such that the remote user input device obtains the fingerprint and sends that fingerprint data to the user device for the user device to determine which finger and which phalange has been read to ascertain which function to perform. Once a user completes such a “learning” mode, the user may be able to assign functions to any one of the surfaces of the phalanges to correspond to a function of the user device.

An advantage to storing the predefined fingerprint data on a user device may include interchangability of the remote user input device between different users such that the remote user input device obtains the fingerprint data and transmits the fingerprint data to a paired user device. The user device may then associate the fingerprint data with the predefined fingerprint data and perform a function corresponding to the predefined fingerprint data. Optionally, a remote user input device according to embodiments of the present invention may store the predefined fingerprint data of multiple users in a memory, such as a memory included in the apparatus 315, such that when the glove 300 is worn by a user, as the fingerprint data is obtained by the fingerprint reading device 325, the user is identified by the predefined fingerprint data.

Each of the front and back surfaces of each of the proximal, intermediate, and distal phalanges of each finger may be assigned a unique function. A function map may be created that correlates each unique fingerprint with a function of the device. The function map may be maintained by the remote user input device or by the user device to which the remote user input device is “paired.” In embodiments where the function map is maintained on the remote user input device, the apparatus 315 may receive obtained fingerprint data from the fingerprint reading device 325, associate the obtained fingerprint data with the predefined fingerprint data to determine which function corresponds to that obtained fingerprint data, and send notice of the corresponding function to the user device. Remote user input devices of embodiments in which the function map is maintained on the user device may assign an identifier to each fingerprint such that when the fingerprint data is obtained, the apparatus 315 sends the identifier of that obtained fingerprint data to the user device. The device may then determine which function corresponds to that identifier and executes the function.

While the front and back surfaces of each of the proximal, medial, and distal phalanges of each finger provide 24 fingerprints for each hand, some surfaces of the back of the fingers may prove difficult to use reliably (e.g., the fingerprint reader may not consistently read them accurately). Further, the back surfaces of the distal phalanges may be difficult to reliably read with the fingerprint reading device 325 as fingernails may often occupy most of the surface, and since fingernails are constantly growing, the surface is constantly changing. Thus, illustrated embodiments of the present invention depict using only the back surface of the medial phalanges of the fingers and using each of the proximal, medial, and distal surfaces of the phalanges on the front of the fingers providing 16 fingerprints for which functions can be assigned on one hand of a user. While the illustrated embodiments depict functions assigned only to one hand of a user, embodiments of the present invention may be configured to read fingerprints of the second hand of the user expanding the number of potential functions available. Further, embodiments of the present invention may be ambidextrous for use on either the left or the right hand of a user.

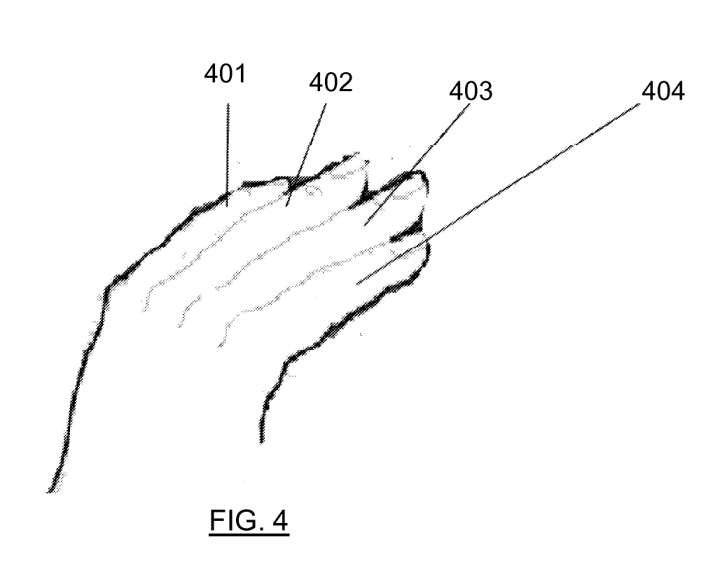

According to example embodiments of the remote user input device of the present invention, the glove 300 may be worn whether or not the user device is in use. In this regard, a need exists to be able to “wake up” or unlock the input device to preclude accidental input. FIG. 4 illustrates a configuration that may be employed to perform such functions. As illustrated, each of the back surfaces of the intermediate phalanges is assigned a function. For example, the function of 401 may include an “unlock” function that wakes-up or turns-on the remote user input device such that it is ready to receive further inputs. The function of 402 may include a mode selection, such as “phone mode” which may dictate the configuration for the inputs of the input device. The function of 403 may include another mode selection, such as “music mode” while 404 may include a “lock” function that directs the remote user input device to not accept any further inputs until it is subsequently “unlocked”

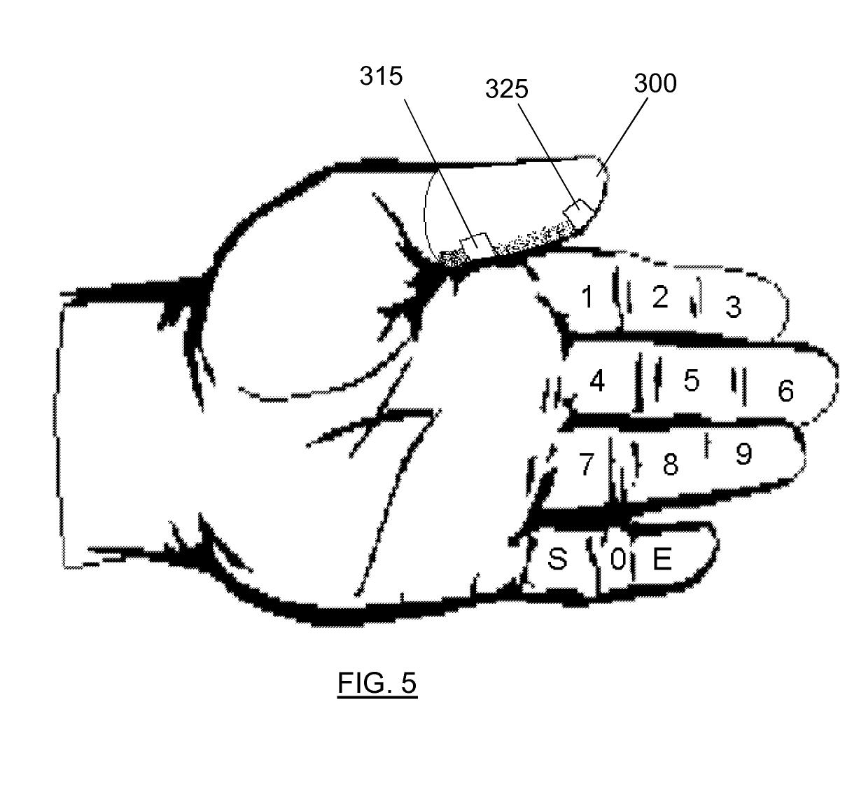

FIG. 5 illustrates how the remote user input device may be used, possibly in conjunction with the embodiment of FIG. 4, as a typical 10-digit numerical keypad further including a “send” (identified by an “S”) and an “end” (identified by an “E”) function. An embodiment of the remote user input device 300 is illustrated as worn on a thumb of a hand, including the fingerprint reading device 325 and the apparatus 315 which may be capable of processing data and/or communication with a user device as described above. A method of operation of the remote user input device 300 according to embodiments of the present invention may begin with a user wearing the glove touching a phalange corresponding to the “unlock” function as shown as 401 in FIG. 4. The user may then touch various phalanges on the front of the fingers corresponding to numbers in a sequence so as to dial a phone number. Upon entering the sequence of numbers, the user may press the “send” button to initiate a phone call, and “end” to terminate the phone call.

Use of the remote user input device according to embodiments of the present invention may mimic the use of a typical keypad of a user device such that a user does not need to re-learn a new style of input. The functions associated with each of the fingerprints in the predefined fingerprint data may also be user-configurable such that the user can select the desired functional lay-out or function map for use with their device. The function map may be user device dependent such that a remote user input device may be configured to operate with multiple user devices and with each device, a different function map may be used. For example, if the remote user input device is “paired” with a mobile phone, the function map may correspond to the 10-digit numerical keypad including “send” and “end” as described above. If the remote user input is “paired” with a television to function as a remote control, an alternative function map may be employed that includes the 10-digit numerical keypad with a “last channel” function and a “pause/play” function.

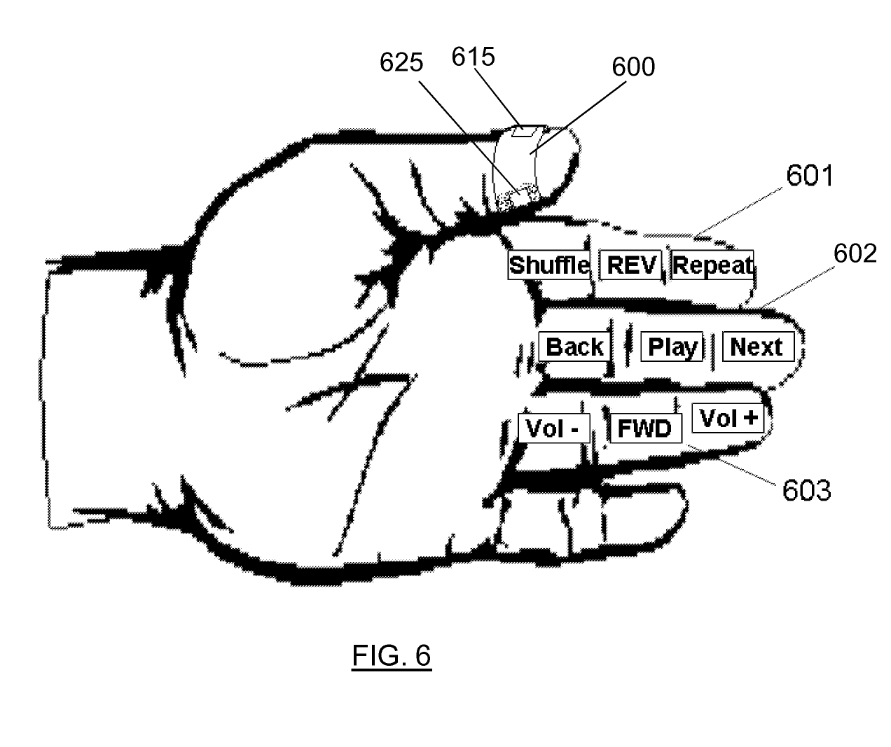

As user devices often have multiple functions, such as a mobile phone that is also a music player device, the remote user input device may be capable of switching between function maps while “paired” with a single user device. FIG. 6 illustrates an example embodiment of a remote user input device 600 according to another example of the present invention used in concert with an example embodiment of a function map that may corresponds to the functional inputs of a user device in a music player mode. The remote user input device 600 of FIG. 6 is illustrated as a band, rather than a glove, as worn by the thumb. The remote user input device may include a fingerprint reader 625 and an apparatus 615 similar to the remote user input device of FIG. 5. Although shown as both a glove and a band, the remote user input device may be embodied in a variety of wearable forms such as a clip or an adhesive backed patch among others. As shown, the front surface of the index finger 601 may include “Shuffle”, “REV” to rewind, and “Repeat” as are common functions on a music playing device. The front surface of the middle finger 602 may include “Back”, “Play/Pause”, and “Next” functions while the ring finger surface 603 includes the volume up/down functions and the fast forward function. As noted above, the function map may be user configurable such that functions can be reassigned to other fingerprints. The remote user input device may switch between function maps based on the active application of the user device, and/or the remote user input device may be able to select between applications on a device. Referring back to FIG. 4, the back surface of the medial phalange of the ring finger 402 may correspond to a “music mode” while the back surface of the medial phalange of the middle finger 403 may correspond to a “phone mode” such that the user can readily switch between applications using the remote user input device.

Additionally, the function map may be switched by the user device without user input in instances such as when a user is listening to music and the music player function map is active and a phone call is received by the user device. The user device may cause the remote user input device to switch from the music player mode to the phone mode (e.g., 10-digit keypad with send/end functions as described above). Optionally, there may be a separate function map that corresponds to an incoming phone call during music player mode in which abbreviated functions or phone call specific functions are available to a user, such as “answer” and “ignore” among other possible functions.

As a display may not be visible for a user device while operating a remote user input device according to embodiments of the present invention, the remote user input device may be configured to provide non-visual feedback to a user to confirm that an instruction was received when the fingerprint reader is applied to a fingerprint. Such non-visual feedback may be in the form of an audible tone or a vibratory response from the user device, the remote user input device, or another accessory such as a headset worn by the user.

To improve the success rate with which obtained fingerprint data corresponds to predefined fingerprint data and to accommodate slight variations in a user's fingerprints, a confidence level may be used to associate obtained fingerprint data with predefined fingerprint data. As a fingerprint may include variations caused by issues such as lacerations, blisters, dirt, or other sources, the fingerprint of a user may be slightly different than the fingerprint learned by the remote user input device. To reduce errors in associating the obtained fingerprint data with the predefined fingerprint data, embodiments of the present invention may allow obtained fingerprint data that is, for example, 90% similar to predefined fingerprint data to be associated with that data. Thus a perfect match is not always necessary. This confidence level implementation may also reduce reading errors caused by the fingerprint reader not being placed in the same location of each fingerprint for each touch of that fingerprint.

As applications are added to a user device for which additional functions and additional function maps may be desired, the application may include a default function map that includes the most prevalent functions used by the application. These default function maps may be altered by a user to suit the user's personal preferences; however, a default function map may be desirable for a user that does not want to create a function map for new applications that they may add to their user device.

Further embodiments of the remote user input device may include functions assigned in a function map to fingerprint sequences to expand the capabilities of the remote user input device. In such an embodiment, a delay may be incorporated between the reading of a fingerprint and the sending of a function to the user device. The delay may be present to await a second fingerprint that is used in a sequence of fingerprints to access a function that is different from the function associated with the fingerprint first touched in the sequence.

A method according to an example embodiment of the present invention is illustrated in the flowchart of FIG. 7 in which a fingerprint is obtained at 701 by, for example, the fingerprint reading device 325 of FIG. 3 or as received at 36 of a user device. It is then determined at 702 whether or not the fingerprint data corresponds to predefined fingerprint data that may be stored, for example, in a memory device of apparatus 315 of the glove 300 of FIG. 3 or in a memory 62 of a user device. If the fingerprint data does not correspond to any predefined fingerprint data, a request for re-read may optionally be sent at 703. The request for re-read may be in the form of a signal sent to the device which may produce an audible tone or a vibratory response. Alternatively, a null response may be representative of an obtained fingerprint not corresponding to any predefined fingerprint data. At 704, the function associated with the predefined fingerprint data is determined Direction is given at 705 to initiate the function. The function may be sent as a multi-step process in a message or it may be a sequence of functions depending on the function associated with the predefined fingerprint data. Optionally, a confirmation of the success of the association of the fingerprint data with predefined fingerprint data may be sent at 706 which may result in a tone emitted by the device or possibly a headset connected to the device or a vibratory response from the device.

As described above and as will be appreciated by one skilled in the art, embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
obtaining fingerprint data regarding a surface of any one of a plurality of phalanges of one or more fingers;
associating the fingerprint data with predefined fingerprint data of a respective phalange of a finger;
determining a function associated with the predefined fingerprint data, wherein different functions are associated with the predefined fingerprint data of different respective phalanges of one or more fingers; and
directing that the function be initiated.

2. A method according to claim 1, further comprising providing for a confirmation in response to associating the fingerprint data with predefined fingerprint data of a respective phalange of a finger.

3. A method according to claim 1, wherein determining a function associated with the predefined fingerprint data comprises referencing a function map.

4. A method according to claim 3, wherein the function map is user selectable.

5. A method according to claim 4, wherein the function associated with the predefined fingerprint data causes a phone call to be initiated.

6. A method according to claim 1, wherein directing that the function be initiated causes a user device to perform the function associated with the predefined fingerprint data.

7. A method according to claim 1, wherein directing that the function be initiated comprises providing for transmission of the function over a personal wireless area network.

8. An apparatus comprising at least one processor and at least one memory including computer program code, the at least one memory and the computer program code configured to, with the at least one processor, cause the apparatus to at least perform:
obtaining fingerprint data regarding a surface of any one of a plurality of phalanges of one or more fingers;
associating the fingerprint data with predefined fingerprint data of a respective phalange of a finger;
determining a function associated with the predefined fingerprint data, wherein different functions are associated with the predefined fingerprint data of different respective phalanges of one or more fingers; and
directing that the function be initiated.

9. An apparatus according to claim 8, wherein the at least one memory and the computer program code are configured to, with the at least one processor, cause the apparatus to provide for a confirmation in response to associating the fingerprint data with predefined fingerprint data of a respective phalange of a finger.

10. An apparatus according to claim 8, wherein determining a function associated with the predefined fingerprint data comprises referencing a function map.

11. An apparatus according to claim 10, wherein the function map is user selectable.

12. An apparatus according to claim 8, wherein directing that the function be initiated comprises providing for transmission of the function over a personal wireless area network.

13. An apparatus according to claim 8, wherein the apparatus is configured to be worn by a user on at least one of a finger and a thumb.

14. A computer program product comprising at least one computer-readable storage medium having computer-executable program code instructions stored therein, the computer-executable program code instructions comprising:
program code instructions for obtaining fingerprint data regarding a surface of any one of a plurality of phalanges of one or more fingers;
program code instructions for associating the fingerprint data with predefined fingerprint data of a respective phalange of a finger;
program code instructions for determining a function associated with the predefined fingerprint data, wherein different functions are associated with the predefined fingerprint data of different respective phalanges of one or more fingers; and
program code instructions for directing that the function be initiated.

15. A computer program product according to claim 14, wherein the program code instructions for determining a function associated with the predefined fingerprint data comprises program code instructions for referencing a function map.

16. A computer program product according to claim 14, further comprising program code instructions for providing for a confirmation in response to associating the fingerprint data with predefined fingerprint data of a respective phalange of a finger.

17-23. (canceled)
